(19) United States
(12) Patent Application Publication
(10) Pub. No.: US 2015/0152819 A1
(43) Pub. Date: Jun. 4, 2015

(54) SELF-ADJUSTING RESONATOR

(71) Applicant: MANN+HUMMEL GMBH, Ludwigsburg (DE)

(72) Inventor: Michael Desjardins, Willow Springs, NC (US)

(73) Assignee: MANN+HUMMEL GMBH, Ludwigsburg (DE)

(21) Appl. No.: 14/097,035

(22) Filed: Dec. 4, 2013

(51) Int. Cl. F02M 35/12

(52) U.S. Cl. CPC F02M 35/1255

(57) ABSTRACT

A self-adjusting resonator for an engine includes a housing and a working chamber. The working chamber is defined by the housing for attenuating sound produced by the engine. The working chamber is automatically variable from a first volume to a second volume in response to a negative pressure generated by air flow requirements of the engine. The first volume is greater than the second volume. The resonator is operable to tune out multiple tuning frequencies produced by the engine at various engine RPM ranges.

### FIELD

The present teachings generally relate to a self-adjusting resonator. More particularly, the present teachings relate to a resonator that adjusts its frequency based on the operating characteristics of an engine.

### BACKGROUND

This section provides background information related to the present disclosure which is not necessarily prior art.

Air induction systems are used in automobiles and other motor vehicles to transport air from the environment to the engine for combustion. As air moves through the air induction system and into the engine, noise and vibration from the engine may be transmitted and amplified by the passages forming the air induction system. It order to reduce the volume and other characteristics of these noises, it may be desirable to utilize a resonator that vibrates at a frequency equal and opposite to that produced by the engine. In this manner, sound waves may be produced that cancel the sound waves produced by the engine.

As the operating characteristics of the engine change, it may be desirable to adjust the frequency of the resonator to effectively respond to the changing sound waves produced by the engine. For example, when the engine is running at low RPM, it may be desirable to have a low frequency resonator to effectively suppress the sound waves produced by the engine. When the engine is running at high RPM, it may be desirable to have a high frequency resonator to effectively suppress the sound waves produced by the engine.

While known resonators have generally proven to be acceptable for their intended purposes, a continued need in the relevant art remains.

### SUMMARY

This section provides a general summary of the disclosure, and is not a comprehensive disclosure of its full scope or all of its features.

According to one particular aspect, the present disclosure provides a self-adjusting resonator for an engine. The resonator includes a housing and a working chamber. The working chamber is defined by the housing for attenuating sound produced by the engine. The working chamber is automatically variable from a first volume to a second volume in response to a negative pressure generated by air flow requirements of the engine. The first volume is greater than the second volume. The resonator is operable to tune out multiple tuning frequencies produced by the engine at various engine RPM ranges.

According to another particular aspect, the present disclosure provides a self-adjusting resonator for an engine. The resonator includes a housing, a plate, and a biasing member. The housing defines a fixed volume cavity. The plate is disposed within the cavity and divides the cavity into a working chamber and a non-working chamber. The plate is movable between a first operating position in which the working chamber has a first volume and a second operating position in which the working chamber has a second volume. The biasing member biases the plate toward the first operating position.

According to a further particular aspect, the present disclosure provides an air induction system for delivering intake air to a combustion engine of a vehicle. The air induction system includes an air duct and a resonator. The air duct defines an air flow path in fluid communication with the engine. The resonator extends generally perpendicular to the air flow path and defines a working chamber having a volume which varies in response to a velocity of air flow along the air flow path. The resonator is operable to tune out multiple tuning frequencies produced by the engine at various engine RPM ranges.

According to yet another particular aspect, the present disclosure provides a method of attenuation of sound produced by an engine. The method includes providing a resonator defining a working chamber having a variable volume. The method also includes routing a flow of air flow past the resonator to automatically reduce the variable volume of the working chamber in response to a negative pressure. The method further includes tuning out multiple tuning frequencies produced by the engine at various engine RPM ranges.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a simplified schematic view of an air induction system including a self-adjusting resonator in accordance with the teachings of the present disclosure.

FIG. 2 is a perspective view of the self-adjusting resonator of FIG. 1, the self-adjusting resonator shown operatively supported by a duct.

FIG. 3 is a cross-sectional view of the self-adjusting resonator of FIG. 2, the self-adjusting resonator shown in a first operating condition.

FIG. 4 is a cross-sectional view similar to FIG. 3, the self-adjusting resonator shown in a second operating condition.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

With general reference to the drawings, an air induction system constructed in accordance with the present teachings is illustrated and identified at reference character 10. The air induction system 10 may be used to transport and filter air from and between the environment and an engine (not shown) or other device utilizing a flow of air. As will be described in more detail below, the air induction system 10 may also be used to affect the noise produced by the engine. By way of example only, the air induction system 10 may be used to produce sound waves that can cancel out or otherwise tune sound waves produced by the engine.

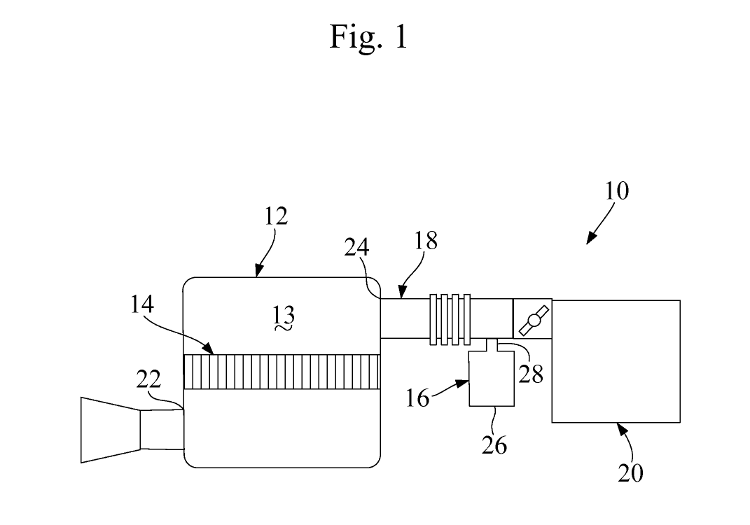

With particular reference to the simplified schematic view of FIG. 1, the air induction system 10 may generally include a housing 12, a filter 14, a resonator 16, and a duct 18. Air from the environment may generally travel through the air induction system 10 to an engine 20 by passing through the housing 12, the filter 14, the resonator 16, and the duct 18. The engine may be an internal combustion engine 20 for a motor vehicle (not shown). The housing 12 may define a chamber 13 and may include an inlet 22 in fluid communication with the environment and an outlet 24 in fluid communication with the duct 18. The filter 14 may be disposed between the inlet 22 and the outlet 24. The filter 14 may conventionally filter or clean the air as it travels through the housing 12 from the environment to the duct 18.

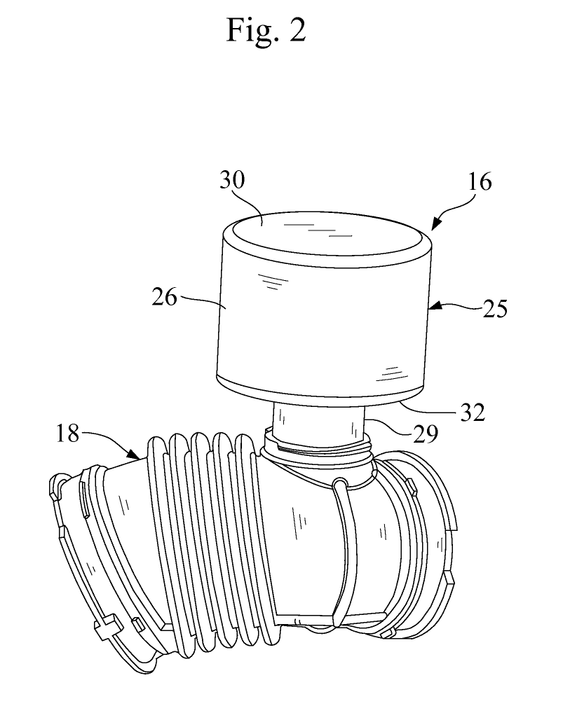

With particular reference to FIGS. 2 through 4, the resonator 16 of the present disclosure will be further described. As illustrated, the resonator 16 may include a housing 25 having a first portion 26 and a second portion 28. The first portion 26 may be a main or base portion 26. The second portion may be a neck portion 28. As illustrated, the base portion 26 may be a cylinder extending between a first end 30 and a second end 32 along a first longitudinal axis 34. It will be appreciated, however, that the base portion 26 may have alternative geometries within the scope of the present teachings. The base portion 26 may define a cavity 36 with the first end 30 being generally closed and the second end 32 being open and in fluid communication with the neck portion 28. The cavity 36 has a fixed volume.

The neck portion 28 may similarly be a cylinder. Again, the neck portion 28 may have alternative geometries within the scope of the present teachings. The neck portion 28 may have a second longitudinal axis 38 extending between a first end 40 and a second end 42. The neck portion 28 may define a cavity 44 with the first and second ends 40, 42 being open. The second end 42 may be mounted to and in fluid communication with the duct 18. The first end 40 of the neck portion 28 may be mounted to and in fluid communication with the second end 32 of the base portion 26. The first end 40 may be welded, mechanically fastened (e.g., threaded engagement), or otherwise suitably fastened to the second end 42. In one configuration, the neck portion 28 may be integrally formed with the base portion 26 from a unitary piece of material by deep drawing or another suitable manufacturing process. The neck portion 28 may be concentrically mounted to the base portion 26 such that the first longitudinal axis 34 is substantially aligned with the second longitudinal axis 38.

The cavity 36 defined by the base portion 26 may have a height H1 and a diameter D1. The cavity 44 defined by neck portion 28 may have a height H2 and a diameter D2. In particular configurations, the ratio of H1 to H2 may be between approximately 1:1 and 3:1. In such particular configurations, the ratio of D1 to D2 may be between approximately 3:2 and 4:1. In one specific configuration, the ratio of H1 to H2 is approximately 2:1 and the ratio of D1 to D2 is approximately 3:1. In one particular application, H1 is approximately eighty millimeters, H2 is approximately forty millimeters, D1 is approximately one hundred millimeters, and D2 is approximately thirty-five millimeters.

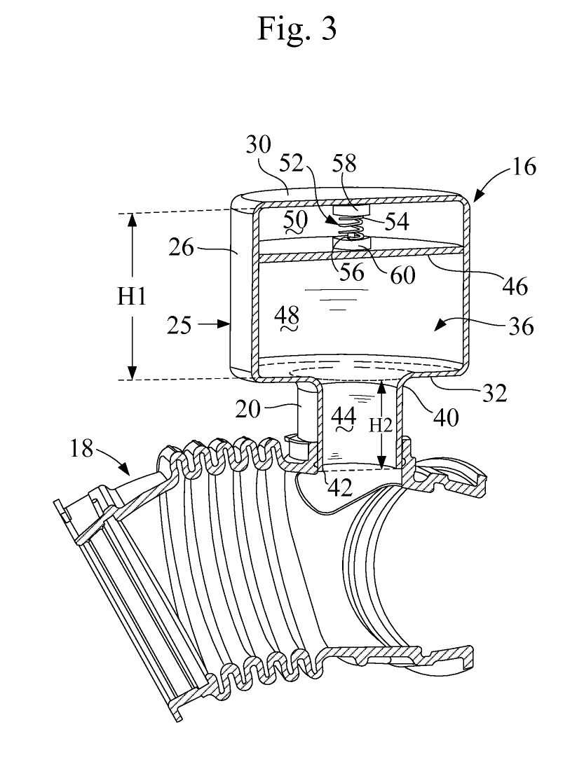

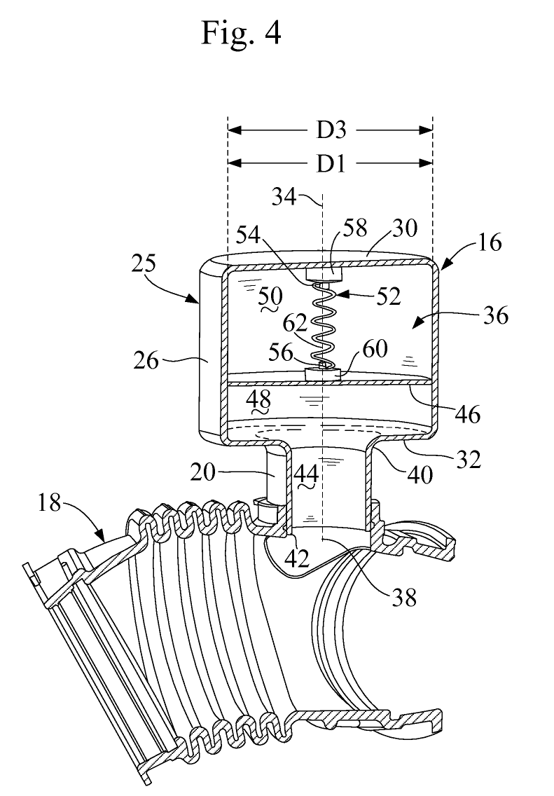

The resonator 16 may further include a divider 46 for dividing the cavity 36 into a working chamber 48 and a non-working chamber 50. As will be addressed herein, the divider 46 may be movable within the cavity 36 such that a volume of the working chamber 48 may vary. As illustrated, the divider may be a plate 46 linearly translatable along the longitudinal axis 34 between a first operating position (generally shown in FIG. 3) and a second operating position (generally shown in FIG. 4). When the plate 46 is in the first operating position, the resonator 16 is in a first operating condition and the working chamber 48 may have a first volume. When the plate 46 is in the second operating position, the resonator 16 is in a second operating condition and the working chamber 48 may have a second volume. In one particular application, the first volume may be about six tenths (0.6) of a liter and the second volume may be less than or equal to fifteen hundredths (0.15) of a liter. It will be appreciated, however, that the first and second volumes may vary within the scope of the present teachings, depending upon particular sound attenuation requirements. It will also be appreciated that when the second volume is equal to zero liters, the cavity 44 defined by the neck portion 28 may form a resonator that is similar to a one-quarter (¼) wave resonator.

The plate 46 may be coupled to the housing 25 through a biasing member 52. The biasing member 52 may generally bias the plate 46 toward the first end 30 and may include a first end 54 fixed to the first end 30 of the base portion 26 and a second end 56 fixed to the plate 46. In one configuration, the base portion 26 may carry a first hub 58 and the plate 46 may carry a second hub 60. The first end 54 of the biasing member 52 may be mounted to the first hub 58. The second end 56 may be mounted to the second hub 60. A longitudinal axis 62 of the biasing member 52 may be aligned with the longitudinal axes 34, 38 of the base portion 26 and neck portion 28, respectively. The plate 46 may be circular in shape and have a diameter D3 approximately equal to the inner diameter D1 of the base portion. Accordingly, as the biasing member 52 is compressed or extended, the plate 46 may move in the direction of the longitudinal axis 34 within the non-working chamber 50 of the cavity 36, thus changing the volumes of the chambers 48 and 50. While the resonator 16 is described as including a single biasing member 52, it is also understood that the resonator 16 may include more than one biasing member within the scope of the present teachings.

Operation of the air induction system 10 will now be described in more detail. When the engine 20 is not operating or air is otherwise not passing through the duct 18, the biasing member 52 may bias the plate 46 in the first operating position (FIG. 3), proximate the first end 30 of the base portion 26. When the engine 20 is operating or air is otherwise traveling through the duct 18, the air passing over the second end 42 of the neck portion 28 may reduce the pressure within the cavity 44 of the neck portion 28 and produce a corresponding pressure reduction within the working chamber 48 of the cavity 36. The reduction of pressure within the working chamber 48 of the cavity 36 may apply a vacuum force on the plate 46 that overcomes the force of the biasing member 52, and thus causes the plate 46 to move along the longitudinal axis 34 within the cavity 36 in the direction of the second end 32 of the base portion 26. As the plate 46 moves within the cavity 36, the volume of the working chamber 48 will decrease.

As the speed of the engine 20 increases or the volumetric flow rate of air through the duct 18 otherwise increases, it may further reduce the pressure within the cavity 44 and within the working chamber 48 of the cavity 36. This further reduction of pressure within the working chamber 48 of the cavity 36 and corresponding increase the amount of force on the plate 46 may overcome the additional force of the biasing member 52 and cause the plate 46 to move further in the direction of the longitudinal axis 34 within the cavity 36 toward the second end 32 of the base portion 26 (FIG. 4). When the volumetric flow rate of air through the duct 18 sufficiently increases, the volume of the first portion 32a of the cavity 36 may approach zero.

As the speed of the engine 20 increases, the frequency of the sound waves produced by the engine 20 may also increase. In addition, as the plate 46 moves within the cavity 36 based on the speed of the engine 20 (as described above), the volume of the working chamber 48 of the cavity 36 may decrease. As the volume of the working chamber 48 decreases, the frequency of the sound waves produced by the resonator 16 may increase to match the frequency of the sound waves produced by the engine. Likewise, as the speed of the engine 20 decreases and the frequency of the sound waves produced by the engine 20 decreases, the volume of the working chamber 48 increases and the frequency of the sound waves produced by the resonator 16 decreases. In this manner, the frequency of the sound waves produced by the resonator 16 can be tuned to self-adjust for automatically matching the frequency of the sound waves produced by the engine 20 and thereby cancel or reduce the amount of noise produced by the engine.

It will now be understood that the present teachings provide a self-adjusting resonator 16 for an engine 20 that includes a working chamber with a variable volume. The volume varies in response to negative pressure created by air flow requirements of the engine 20. The resonator 16 may tune out multiple tuning frequencies at varying engine RPM ranges.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A self-adjusting resonator for an engine, the self-adjusting resonator comprising:
a housing; and
a working chamber defined by the housing for attenuating sound produced by the engine, the working chamber being automatically variable from a first volume to a second volume in response to a negative pressure generated by air flow requirements of the engine, the first volume being greater than the second volume;
wherein the resonator is operable to tune out multiple tuning frequencies produced by the engine at various engine RPM ranges.

2. The self-adjusting resonator of claim 1, wherein the housing defines a cavity having a fixed volume, the cavity including the working chamber and a non-working chamber.

3. The self-adjusting resonator of claim 2, further comprising a divider separating the cavity into the working chamber and the non-working chamber.

4. The self-adjusting resonator of claim 3, wherein the divider is biased such that the working chamber has the first volume.

5. The self-adjusting resonator of claim 3, wherein the divider is linearly movable between a first operating position and a second operating position.

6. The self-adjusting resonator of claim 5, further comprising a spring biasing the divider to the second operating position.

7. The self-adjusting resonator of claim 1, in combination with an air induction system including an air duct, the working chamber in fluid communication with an air path extending through the air duct.

8. A self-adjusting resonator for an engine, the resonator comprising:
a housing defining a fixed volume cavity;
a plate disposed within the cavity and dividing the cavity into a working chamber and a non-working chamber, the plate movable between a first operating position in which the working chamber has a first volume and a second operating position in which the working chamber has a second volume; and
a biasing member biasing the plate toward the first operating position.

9. The self-adjusting resonator of claim 8, wherein the working chamber is adapted to be in fluid communication with a flow of air that creates a negative pressure and wherein the negative pressure reacts a bias of the biasing member to decrease a variable volume of the working chamber.

10. The self-adjusting resonator of claim 9, wherein the variable volume of the working chamber is operable to tune out multiple tuning frequencies at varying engine RPM ranges.

11. The self-adjusting resonator of claim 8, wherein the plate is linearly movable within the cavity.

12. The self-adjusting resonator of claim 8, wherein the biasing member is a coil spring.

13. The self-adjusting resonator of claim 8, wherein the biasing member is a coil spring disposed within the non-working chamber.

14. The self-adjusting resonator of claim 8, in combination with an air induction system including an air duct, the working chamber in fluid communication with an air path extending through the air duct.

15. An air induction system for delivering intake air to a combustion engine of a vehicle, the air induction system comprising:
an air duct defining an air flow path in fluid communication with the engine; and
a resonator extending generally perpendicular to the air flow path and defining a working chamber having a volume which varies in response to a velocity of air flow along the air flow path;
wherein the resonator is operable to tune out multiple tuning frequencies produced by the engine at various engine RPM ranges.

16. The air induction system of claim 15, wherein the housing defines a cavity having a fixed volume the cavity including the working chamber and a non-working chamber.

17. The air induction system of claim 16, wherein the housing includes a main portion defining the cavity and a neck portion between the main portion and the air flow path.

18. The air induction system of claim 17, wherein the main portion and the neck portion are cylindrical.

19. The air induction system of claim 18, wherein the main portion has a first inner diameter and the neck portion includes a second inner diameter, the first inner diameter being greater than the second inner diameter.

20. A method of attenuation of sound produced by an engine, the method comprising:
providing a resonator defining a working chamber having a variable volume;
routing a flow of air flow past the resonator to automatically reduce the variable volume of the working chamber in response to a negative pressure; and
tuning out multiple tuning frequencies produced by the engine at various engine RPM ranges.
